(19) United States
(12) Patent Application Publication
(10) Pub. No.: US 2007/0058182 A1
(43) Pub. Date: Mar. 15, 2007

(54) Multiple spatial light modulators in a package

(75) Inventor: Andrew Huibers, Palo Alto, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/514,077

(22) Filed: Aug. 30, 2006

Related U.S. Application Data
(60) Provisional application No. 60/713,005, filed on Aug. 30, 2005.

(51) Int. Cl. G06F 15/00; H04N 1/60

(52) U.S. Cl. 358/1.9

(57) ABSTRACT

Multiple pixel arrays are enclosed in one single package. The multiple pixel arrays can be disposed in the package with any desired geometric configurations.

### CROSS-REFERENCE TO RELATED CASES

This US patent application claims priority from U.S. provisional patent application Ser. No. 60/713,005 filed Aug. 30, 2005, the subject matter being incorporated herein by reference in its entirety.

The subject matter of each one of the following patents and patent applications is incorporated herein by reference in entirety.

| Serial/Patent Number | Filling Date |
|---|---|
| 10/443,318 | May 22, 2005 |
| 10/852,981 | May 24, 2004 |
| 11/056,732 | Feb. 11, 2005 |
| 11/056,727 | Feb. 11, 2005 |
| 11/056,752 | Feb. 11, 2005 |
| 10/969,258 | Oct. 19, 2004 |
| 10/005,308 | Dec. 3, 2001 |
| 10/167,361 | Jun. 11, 2003 |

### TECHNICAL FIELD OF THE INVENTION

The present invention is generally related to the art of spatial light modulators; and more particularly to multiple pixel arrays of spatial light modulators enclosed in a package for use in projection systems.

### BACKGROUND OF THE INVENTION

Current developments in spatial light modulators have expanded the realm of optical processing by integrating the optical and electrical signals. A typical spatial light modulator has an array of individually addressable pixels that are capable of spatially modulating incident light in response to electrical signals that are associated with desired images or videos. The pixels of the spatial light modulator can be reflective and deflectable micromirror devices, liquid crystal cells, liquid-crystal-on-silicon cells, plasma cells, and other microstructures with a characteristic dimension of hundreds of microns or less.

A projector may use a single spatial light modulator for producing images and video, in which the spatial light modulator modulates a sequence of color light beams derived from a white light beam so as to generate color images and videos. A projection system may also use multiple spatial light modulators for modulating different color beams.

Because of the delicate and miniature natural of the pixels, contamination particles, moisture and the like, airflow disturbance, and thermal instability in the operation environment are detrimental, and may cause device failure to spatial light modulators. For this and other reasons, such as handling and installation, spatial light modulators need to be enclosed for protection; which is often performed through packaging.

Regardless of the differences in currently available packaging strategies, each package encloses an array of pixels of a spatial light modulator. When multiple pixel arrays are needed, such as in the display system requiring multiple spatial light modulators, then packaging scheme of enclosing one single pixel array in a package can be far less cost-efficient.

Therefore, what is needed an apparatus and method for enclosing multiple pixels arrays of spatial light modulators.

### SUMMARY OF THE INVENTION

Multiple pixel arrays (spatial light modulators each having an array of pixels) are enclosed in one single package. The pixel arrays are placed on the supporting surface of a package substrate. The supporting surface can be the surface of a cavity in the package substrate, or can be the surface of a planar package substrate. In either instance, the package substrate is bonded to a package cover so as to seal, preferably hermetically, the multiple pixel arrays in the space between the package cover and package substrate.

As an embodiment of the invention, the multiple pixel arrays are formed on a device substrate. Each pixel array has a natural resolution that is lower than or equal to or higher than the resolution of the desired image to be displayed; and different pixel arrays may have different natural resolutions. By “natural resolution” of a pixel array, it is meant the total number of pixels in the array.

The multiple arrays can be formed on a device substrate without singulation but separated by array boundaries. The array boundaries can be vacant sites on the device substrate or any structures that are different from pixels; and can be covered by light blocking/absorbing materials for avoiding unwanted light scattering thereof. Alternatively, the multiple pixel arrays can be formed such that the pixels are substantially continuous throughout the entire area of all multiple arrays with the individual pixel arrays being defined with the aid of a light blocking/absorbing mask. Specifically, the light blocking/absorbing mask may have multiple blank areas surrounded by light blocking segments. When superimposed on the continuous pixel array, pixels exposed from the blank areas are defined as individual pixel arrays. In this aspect, the blank areas are fabricated such that the exposed pixels in each blank area have a natural resolution that is equal to or higher than the resolution of the desired images. The blank areas of the light blocking/absorbing areas may or may not be configured the same. In another alternative embodiment, the multiple pixel arrays are singulated pixel arrays, and are disposed on the supporting surface of the package substrate with a predetermined configuration. A light blocking/absorbing layer can also be provided.

The pixels can be any suitable elements that are capable of modulating a beam of light incident thereon with image data derived from an image. Exemplary such pixels include, but not limited to liquid-crystal cells, liquid-crystal-on-silicon cells, charge-coupled device cells, CMOS image sensor cells, plasma cells, and micromirror devices. When the pixels are micromirror devices, the micromirror devices can be formed on one substrate, such as a semiconductor substrate on which standard integrated circuits can be fabricated using standard integrated circuit fabrication processes, or a single crystal substrate from which deflectable reflective mirror plates of the micromirror devices can be derived. Alternatively, the micromirror devices can be fabricated on multiple substrates, such as a light transmissive substrate and a standard semiconductor substrate.

The light blocking/absorbing materials (layers or the mask) can be formed on the pixel arrays, or on the package cover. Specifically, when the light blocking mask is on the package cover and spaced away from the pixels, the light blocking/absorbing mask may be aligned to the individual pixel arrays according to the propagation path of the incident light to be modulated.

The pixel arrays can be disposed on the supporting surface with any suitable orientations so as to satisfy different optical requirements. For example, all pixel arrays can be placed on the supporting surface at the same level, but one or more pixel arrays can be rotated on the supporting surface, such as along a rotation axis perpendicular to the supporting surface. The pixel arrays can alternatively be disposed on the supporting surface with one or more pixel arrays being rotated along an axis on the supporting surface such that, the rotated pixel array(s) have an angle to the supporting surface. In some instances especially when optical path differences need to be compensated, one or more pixel arrays can be elevated from the supporting surface.

As an exemplary implementation, the device package enclosing multiple pixel arrays can be utilized in projection systems, such as rear-projection systems and front projection systems. Different pixel arrays can be designated to modulate portions of different wavebands of the incident light. In an example wherein the incident light is a mixture of multiple wavebands, the incident light is deposited such that different wavebands are spaced apart and propagate along different paths towards the multiple pixel arrays. Splitting of the wavebands can be accomplished with standard X-beamsplitter, filters of specific optical wavebands, and other suitable optical elements. Different wavebands are incident onto corresponding pixel arrays and modulated thereby. To compensate potential optical path differences of different wavebands, optical-path-difference compensators can be utilized. The modulated light of different wavebands are then combined and projected on display target for viewing.

In an example of rear-projection system, such as rear-projection TV, a folding mirror is provided to project the modulated light from the pixel arrays on the screen. When multiple arrays in the package are coordinated to project the desired image, the gap(s) between the multiple pixel arrays in the package may be imaged on the screen. This problem can be solved by providing a folding mirror that is composed of multiple portions with the multiple portions being folded at suitable angles so as to meld the images from the multiple pixel arrays.

The multiple pixel arrays in the projection system can be operated independently with independent media contents (e.g. images or video streams) so as to produce multiple independent media contents for multiple viewers simultaneously. Specifically, a first and second pixel arrays can be enclosed in a device package. The first and second pixel arrays can be operated in a first operation mode where the first and second pixel arrays' modulation operations are carried out based on portions of the same desired media content. The first and second pixel arrays can be operated in a second mode wherein the first pixel arrays is capable of producing a first stream of media content; while the second pixel array is capable of producing a second stream of media content that is independent and different from the first media content.

The objects and advantages of the present invention will be obvious, and in part appear hereafter and are accomplished by the present invention. Such objects of the invention are achieved in the features of the independent claims attached hereto. Preferred embodiments are characterized in the dependent claims.

### BRIEF DESCRIPTION OF THE DRAWINGS

The accompanying drawings are illustrative and are not to scale. In addition, some elements are omitted from the drawings to more clearly illustrate the embodiments. While the appended claims set forth the features of the present invention with particularity, the invention, together with its objects and advantages, may be best understood from the following detailed description taken in conjunction with the accompanying drawings, in which:

FIG. 1 schematically illustrates an exemplar package with multiple pixel arrays enclosed therein according to an embodiment of the invention;

FIG. 2 is a cross-sectional view of the package in FIG. 1 having an exemplary spatial light modulator according to an embodiment of the invention;

FIG. 3 demonstratively illustrates a portion of the exemplary spatial light modulator in FIG. 2;

FIG. 4 is a cross-sectional view of the package in FIG. 1 having an exemplary spatial light modulator according to another embodiment of the invention;

FIG. 5 demonstratively illustrates a portion of the exemplary spatial light modulator in FIG. 4;

FIG. 6 is a cross-sectional view of the package in FIG. 1 having an exemplary spatial light modulator according to yet another embodiment of the invention;

FIG. 7 demonstratively illustrates a portion of the exemplary spatial light modulator in FIG. 6;

FIG. 8 schematically illustrates a cross-sectional view of an exemplary micromirror device that can be a pixel of the spatial light modulators in FIG. 1 to FIG. 7;

FIG. 9 schematically illustrates a perspective view of a portion of an exemplary micromirror according to an embodiment of the invention;

FIG. 10 schematically illustrates an exemplary scheme where multiple pixel arrays are disposed on a supporting surface of a package substrate;

FIG. 11 schematically illustrates another exemplary scheme where multiple pixel arrays are disposed on a supporting surface of a package substrate;

FIG. 12 schematically illustrates yet another exemplary scheme where multiple pixel arrays are disposed on a supporting surface of a package substrate;

FIG. 13 is a diagram showing an projection system employing multiple pixel arrays of the invention;

FIG. 14 is an exemplary projection system employing multiple pixel arrays according to an embodiment of the invention;

FIG. 15 is another exemplary projection system employing multiple pixel arrays according to another embodiment of the invention;

FIG. 16 is yet another exemplary projection system employing multiple pixel arrays according to yet another embodiment of the invention;

FIG. 17 is yet another exemplary projection system employing multiple pixel arrays according to yet another embodiment of the invention;

FIG. 18 is yet another exemplary projection system employing multiple pixel arrays according to yet another embodiment of the invention;

FIG. 19 is a top view of an exemplary rear-projection system with a folded folding mirror according to an embodiment of the invention;

FIG. 20 is a side view of the exemplary rear-projection system in FIG. 19;

FIG. 21 is yet another exemplary projection system employing multiple pixel arrays with the projection system being capable of providing different viewing contents for different viewers;

FIG. 22 is an exemplary screen of the display target usable in the projection system in FIG. 21;

FIG. 23 illustrates a cross-sectional view of another exemplary device package having multiple pixel arrays that are formed on wafer level;

FIG. 24 illustrates a cross-sectional view of yet another exemplary device package having multiple pixel arrays that are formed on wafer level;

FIG. 25 illustrates a cross-sectional view of yet another exemplary device package having multiple pixel arrays that are formed on wafer level; and

FIG. 26 illustrates a cross-sectional view of yet another exemplary device package having multiple micromirror arrays formed on a semiconductor substrate.

### DETAILED DESCRIPTION OF THE EMBODIMENTS

Multiple pixel arrays are enclosed in one single package, which creates benefits of low production cost, high production yield, and other aspects in product manufacture, as compared to those packages each having only one single pixel array. The pixels of the pixel array can be CCD cells, CMOS image sensor cells, LCD cells, LCOS cells, plasma cells, micromirror devices, or other type of pixels. In the following, the present invention will be discussed with examples wherein the pixels are micromirror devices. It will be appreciated by those skilled in the art that the following discussion is for demonstration purposes, and should be interpreted as a limitation. Other variations without departing from the spirit of the invention are applicable.

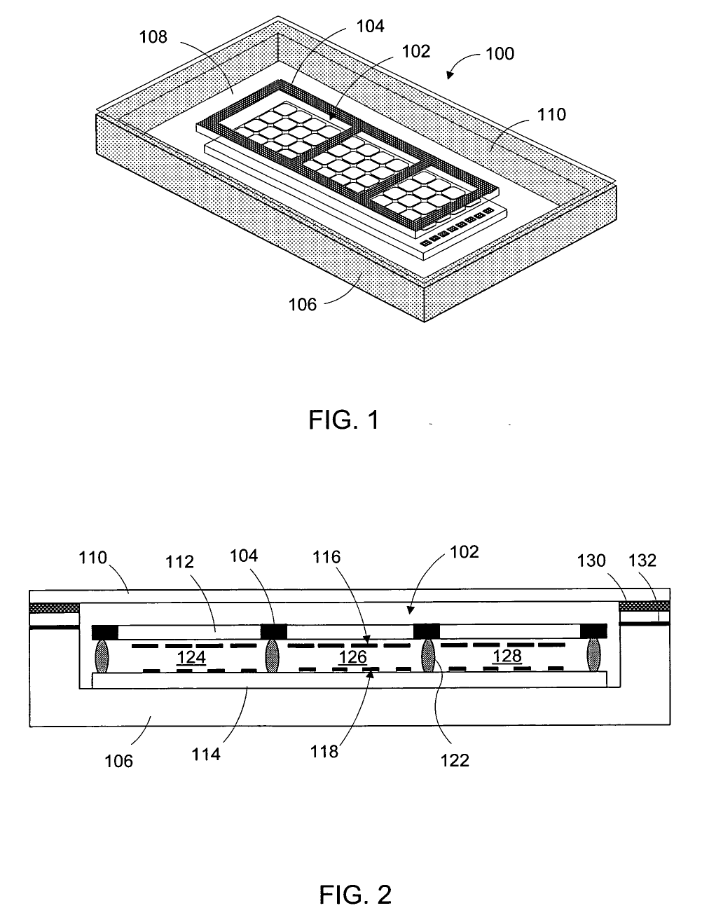

Turning to the drawings, an exemplary package having multiple pixel arrays is illustrated in FIG. 1. Referring to FIG. 1, multiple arrays 102 of multi-array device package 100 are disposed on supporting surface 108 of package substrate 106. Package cover 110 is bonded to the package substrate so as to enclose and seal the multiple pixel arrays within the space between the package cover and package substrate. The seal is preferably hermetic, although is not required to be. Light blocking/absorbing mask 104 can be provided for many purposes, such as to avoid unwanted light scattering from the gaps between multiple micromirror arrays and to define the boundaries of the individual micromirror arrays.

The package substrate may be a multilayered structure, preferably with an integrated heater laminated between the multiple layers, as set forth in U.S. patent application Ser. No. 10/443,318 filed May 22, 2005, and Ser. No. 10/852,981 filed May 24, 2004, the subject matter of each being incorporated herein by reference. The layers of the package substrate can be of any suitable materials, such as ceramic materials, plastic materials, organic or inorganic materials. The layers can also be laminated and patterned to define a cavity in which the multiple pixel arrays can be disposed. Alternatively, the package substrate can be a planar plate, in which instance, a spacer may be necessary to bond the package substrate to the package cover with a space therebetween for accommodating the multiple pixel arrays. The package cover can be a light transmissive substrate, such as glass, quartz, or sapphire. Alternatively, the package cover can be a non-transmissive substrate with light transmissive window, such as a light transmissive inlay window.

The multiple micromirror arrays can be on the same substrate without being singulated, an example of which is shown in FIG. 2. Referring to FIG. 2, micromirror arrays 124, 126, and 128 are disposed on package substrate 106. Light transmissive package cover 110 is hermetically bonded to the package substrate so as to enclose the multiple micromirror device arrays within the cavity between the package cover and package substrate. The hermetic bonding of the package substrate and package cover can be carried out with the aid of integrated heater 132 and suitable sealing medium 130, as set forth in U.S. patent application Ser. No. 10/443,318 filed May 22, 2005, and Ser. No. 10/852,981 filed May 24, 2004.

For simplicity and demonstration purposes, only three micromirror device arrays are illustrated. In general, any suitable number, such as two, four, and even more, of micromirror device arrays can be enclosed in the package.

In the specific example as shown in FIG. 2, each micromirror device array comprises an array of deflectable reflective mirror plates, such as mirror plate array 116. The number of mirror plates in each micromirror device array is equal to or higher than the resolution of the desired media contents (e.g. videos or images) to be projected; and different micromirror device arrays may have different natural resolutions. For example, each micromirror device array may have 512×384 or higher, 960×540 or higher, 1024×768 or higher, and 1920×1080 or higher natural resolutions. The aspect ratio (the ratio of the number of rows to number of columns in the array) can be standard 4:3 or 16:9 or any desired ratios.

An array of addressing electrodes, such as addressing electrode array 118 is placed proximate to and associated with the mirror plates (e.g. mirror plate array 116) for electrostatically deflecting the mirror plates. In an embodiment of the invention, each mirror plate is associated with one single addressing electrode for controlling deflection. In operation, an electrostatic field is established between the mirror plate and associated addressing electrode. The electrostatic field results in an electrostatic force, which in turn, exerts an electrostatic torque to the deflectable mirror plate. Under the electrostatic torque, the mirror plate rotates in a manner defined by the geometric configuration of the micromirror device. For example, by attaching the mirror plate to a torsion hinge with the attachment point away from the mass center of the mirror plate, the mirror plate is capable of rotating asymmetrically along a rotation axis that can be parallel to but offset from a diagonal of the mirror plate when viewed from the top. If the attachment point is substantially at the mass center of the mirror plate, the mirror plate is capable of rotating symmetrically along a rotation axis that is substantially coincident to a diagonal of the mirror plate. For avoiding unwanted light scattering from the torsion hinge to which the mirror plate is attached, the mirror plate can be formed on a separate plane as the hinge to which the mirror plate is attached. Specifically, the hinge can be fabricated underneath the mirror plate in the direction of the incident light.

The mirror plates in the example shown in FIG. 2 are fabricated on light transmissive substrate 112 that is bonded to semiconductor substrate 114 on which the addressing electrodes are formed. The two substrates are bonded with spacers, such as spacer 122 to maintain a uniform and constant distance between the two substrates. Shown in the figure are two spacers for each micromirror array located at the boundaries of the micromirror device array. However, other number of spacers is also applicable. For example, only selected micromirror device arrays (but not all) are provided with spacers between the two substrates. In an extreme instance, the two substrates are bonded by only two spacers. Such two spacers can be located at the furthest micromirror device arrays, or at any locations within the gap between the two substrates.

In another embodiment of the invention, the mirror plates and addressing electrodes of the micromirror device arrays can be formed on the same substrate, such as a semiconductor substrate (e.g. semiconductor substrate 114 in FIG. 2). In yet another embodiment of the invention, the mirror plates can be derived from a single crystal material, such as single crystal silicon, as set froth in U.S. patent application Ser. No. 11/056,732, Ser. No. 11/056,727, and Ser. No. 11/056,752, all filed Feb. 11, 2005, the subject matter of each being incorporated herein by reference.

In the example shown in FIG. 2, the micromirror device arrays are separated by barriers that are vacant sites on substrates 112 and 114. Specifically, no micromirrors are fabricated in the vacant sites. Alternatively, the barriers can be regular micromirror devices (which will be discussed afterwards with reference to FIG. 4) or other structures (preferably non-reflective structures) different from the regular micromirror devices. Each barrier may have a dimension that is one pitch size (which is defined as the center-to-center distance between adjacent mirror plates) or more, such as 5 pitch sizes or more, 10 pitch sizes or more, and 50 pitch sizes or more of the micromirror array. Each barrier may have a width from 14 microns or more, 140 microns or more, and 700 microns or more. When the barriers are composed of regular micromirrors, these micromirrors can be turned off during operation. In order not to image the barriers (and the boundaries) at the micromirror device arrays onto the display target, or to prevent unwanted light scattering from the barriers and boundaries, light blocking/absorbing mask 104 can be provided.

Light blocking/absorbing mask 104 can be formed at any suitable locations of the micromirror device arrays. For example, the mask can be formed on the light transmissive substrate (112) as shown in the figure, or alternatively, on substrate 114, which is not shown in the figure, or on both substrates. Regardless of the different locations of the light blocking/absorbing masks in the micromirror device arrays, it is preferred that the boundaries and barriers of the micromirror device arrays are covered with the light absorbing material so as to blocking or absorbing the light incident thereto. In another embodiment of the invention, the light blocking/absorbing mask can be formed on the light transmissive package cover. In this instance, the mask may need to be aligned to the micromirror device arrays and the boundaries and barriers, as set forth in U.S. patent application Ser. No. 10/969,258 filed Oct. 19, 2004, the subject matter being incorporated herein by reference. In addition to the light blocking/absorbing mask, other light blocking structures having suitable light absorbing/blocking materials can be disposed on the micromirror device arrays and/or the package including the package substrate and package cover.

The light blocking pad/mask may comprise a light absorbing material that absorbs 85% or more, or 90% or more, or 99% or more of the illumination light incident thereto. Alternatively, the light blocking pad may be composed of a light reflective material that reflects 85% or more, or 90% or more, or 99% or more of the illumination light incident thereto. The light blocking pads each can be a single layer or a multilayered structure. The light absorbing material is preferably one that absorbs wavelengths of broad range in the visible spectrum. An opaque material, preferably a black material, is preferred. More specifically, the non-reflective material can be a dark, opaque (e.g. black, grey, or other dark colors) thin film. In particular, the light absorbing material comprises Chromium or chromium oxide Other suitable materials, such as black nickel, CrNₓ, TiAlₓ, TaNₓ, and materials containing carbon, such as amorphous CNₓ, amorphous CAlₓN_{y}, CTiₓN_{y}, a-DLC, vitreous carbon, SiC, TiAlCN, WC, etc, are also applicable. Multilayer structures, such as TiC/WC, WC/C or TiAln/WC/C, can be used, as well as other multilayer structures with matched indices. Also, polymides and other polymers containing carbon black (or other opacity increasing material) can be used. If the light absorbing layer is exposed to an etchant at the time of release of the micromirrors, the light absorbing material should preferably be resistant to the etchant used. Of course, other opaque films (preferably those with high optical density, thermally stable and with low reflectivity) can be used.

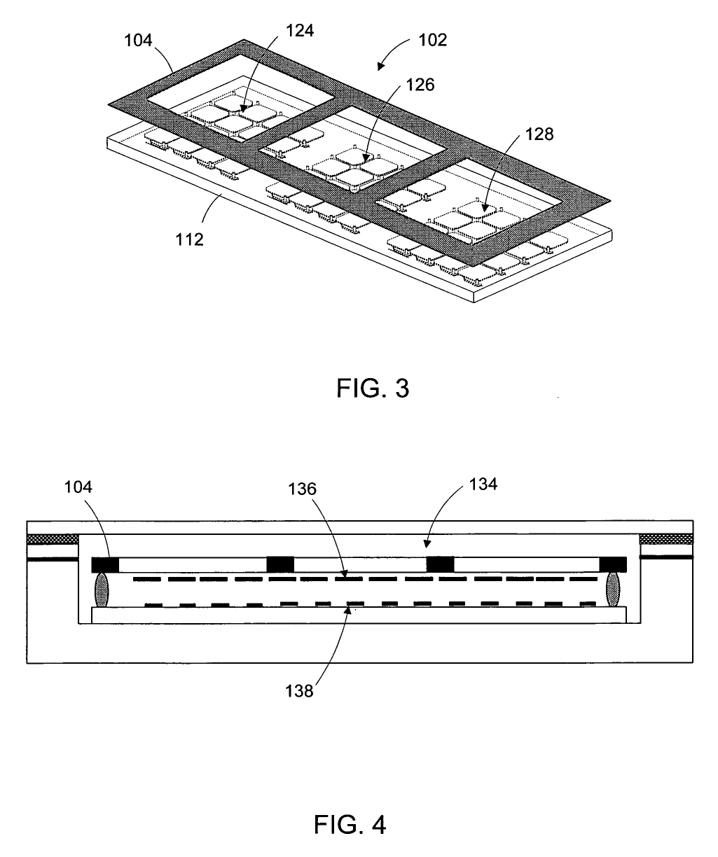

The micromirror device arrays and the light blocking/absorbing mask in the package as shown in FIG. 1 and FIG. 2 can be better illustrated in FIG. 3. Referring to FIG. 3, micromirror device arrays 124, 126, and 128 are fabricated on light transmissive substrate 112 (bottom side in FIG. 3 view). Light blocking/absorbing mask 114 is provided and aligned to the micromirror device arrays so as to blocking/absorbing light reflected from the boundaries and/or barriers at the edges of and/or between the micromirror device arrays.

For simplifying the design, manufacturing, and other reasons, the micromirror devices of the multiple micromirror device arrays can be fabricated continuously throughout the entire area of the multiple micromirror device arrays, as shown in FIG. 4. Referring to FIG. 4, the reflective deflectable mirror plates (e.g. 136) and addressing electrodes (e.g. 138) are continuously fabricated on the light transmissive substrate and semiconductor substrate, but without barriers applied as that in FIG. 2 for isolating the individual micromirror device arrays. In this instance, the individual micromirror device arrays can be defined with the aid of light blocking/absorbing mask 104. The mask comprises blank areas, and is superimposed on the continuous micromirror devices. By properly selecting the sizes and shapes of the blank areas of the mask, multiple micromirror device arrays are exposed to the blank areas, and can thus be operated to project desired media contents. In the embodiment of the invention, the light blocking/absorbing mask is configured such that by superimposing the mask on the continuous micromirror device arrays, the total number of micromirror devices (the natural resolution) exposed from each blacking area of the mask is equal to higher than the resolution of the desired digital media contents. However, the areas and geometric shapes of the blacking areas of the light blocking/absorbing mask may or may not be the same. As an aspect of the embodiment of the invention, the areas and shapes (e.g. the aspect ratios) of the blank areas are dynamically adjustable so as to enable dynamic adjustment of the natural resolution of the effective micromirror array devices.

In an alternatively embodiment, the micromirror arrays can be defined by barriers each of which is composed of regular micromirrors. In operation, the micromirrors of the barriers are operated differently as the other regular micromirrors. For example, in display applications, the regular micromirrors of the array are operated based on the image data derived from the desired image; whereas the micromirrors of the barriers are operated independent from the image data. For example, the micromirrors can be turned to the OFF state during the display application. Each barrier may have a dimension that is one pitch size (which is defined as the center-to-center distance between adjacent mirror plates) or more, such as 5 pitch sizes or more, 10 pitch sizes or more, and 50 pitch sizes or more of the micromirror array. Each barrier may have a width from 14 microns or more, 140 microns or more, and 700 microns or more.

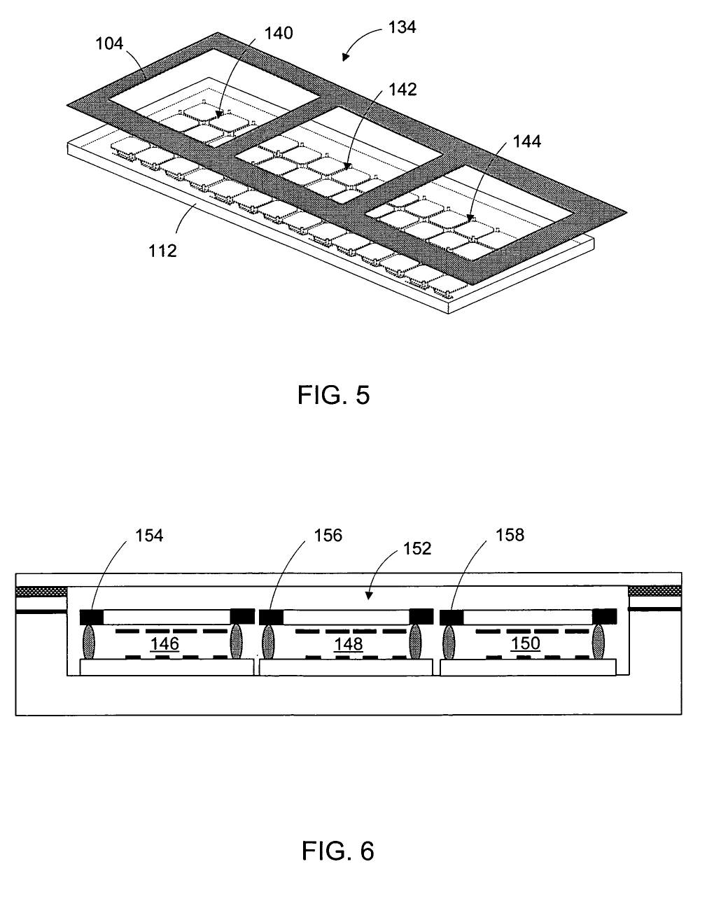

The multiple micromirror device arrays in FIG. 4 are better illustrated in a perspective view in FIG. 5. Referring to FIG. 5, micromirror devices are continuously fabricated on substrate 112. Light blocking/absorbing mask 104 having multiple black areas is superimposed on the continuous micromirror device arrays such that, micromirror device arrays 140, 142, and 144 are defined. The edges and boundaries of the micromirror device arrays are covered by light blocking/absorbing materials.

In the example shown in FIG. 4 and FIG. 5, the micromirror device arrays are formed on multiple substrates—a light transmissive substrate having the reflective deflectable mirror plates formed thereon, and a semiconductor substrate having the addressing electrodes formed thereon. Alternatively, the mirror plates and addressing electrodes can be formed on the same substrate, preferably a semiconductor substrate on which standard integrated circuits can be fabricated using standard integrated circuits' fabrication processes. In another embodiment of the invention, the mirror plates can be derived from a single crystal, such as a single crystal silicon, which will not be discussed in detail.

According to another embodiment of the invention, the multiple micromirror device arrays enclosed in the device package can be singulated micromirror device arrays, as demonstratively shown in FIG. 6. Referring to FIG. 6, the individual micromirror device arrays 146, 148, 150 are separate micromirror device arrays; and are enclosed within the space between the package substrate and package cover. The package substrate and package cover may or may not be the same as those described with reference to FIG. 2 and FIG. 4. As seen in the figure with the objects in the drawing not in scale, the multiple micromirror device arrays are formed on separate (e.g. singulated) substrates. Two substrates of each micromirror device array are bonded with one or more spacers for maintaining constant and uniform distances between the substrates. Each micromirror device array may alternatively be provided with a light blocking/absorbing mask, such as masks 154, 156, and 158 for preventing unwanted light scattering. The light blocking/absorbing masks can be formed on the micromirror device arrays, or alternatively on the light transmissive package substrate.

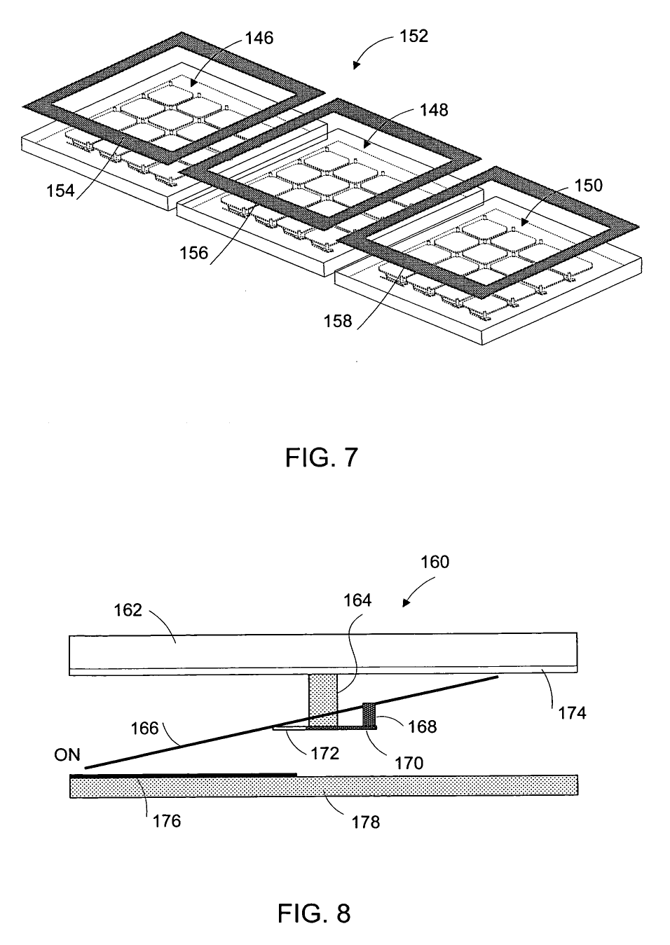

A perspective view of the multiple micromirror device arrays in FIG. 6 is better illustrated in FIG. 7. Referring to FIG. 7, individual micromirror device arrays 146, 148 and 150 each are provided with a light blocking/absorbing mask 154, 156, and 158.

The micromirror devices in the multiple micromirror device arrays can be of any suitable architecture, one of which is demonstratively illustrated in a side view as shown in FIG. 8. Referring to FIG. 8, micromirror device 160 comprises reflective deflectable mirror plate 166 that is attached to deformable hinge 170 via hinge contact 168. The deformable hinge, such as a torsion hinge is held by a hinge support that is affixed to post 164 on light transmissive substrate 162. Addressing electrode 176 is disposed on semiconductor substrate 178, and is placed proximate to the mirror plate for electrostatically deflecting the mirror plate. Other alternative features can also be provided. For example, stopper 172 can be provided for limiting the rotation of the mirror plate when the mirror plate is at the desired angles, such as the ON state angle. The ON state angle is preferably 10° degrees or more, 12° degrees or more, or 14° degrees or more relative to substrate 162. For enhancing the transmission of the incident light through the light transmissive substrate 162, anti-reflection film 174 can be coated on the lower surface of substrate 162. Alternative the anti-reflection film, a light transmissive electrode can be formed on the lower surface of substrate 162 for electrostatically deflecting the mirror plate towards substrate 162. Other optical films, such as a light transmissive and electrically insulating layer can be utilized in combination with the light transmissive electrode on the lower surface of substrate 162 for preventing possible electrical short between the mirror plate and light transmissive electrode.

In the example shown in FIG. 8, the mirror plate is associated with one single addressing electrode on substrate 178. Alternatively, another addressing electrode can be formed on substrate 178, but on the opposite side of the deformable hinge.

Instead of forming the mirror plate and addressing electrode on separate substrates, the mirror plate and addressing electrode can be formed on the same substrate, such as semiconductor substrate 178. Alternatively, the mirror plate can be derived from a single crystal material such as a single crystal silicon, which will not be discussed in detail herein.

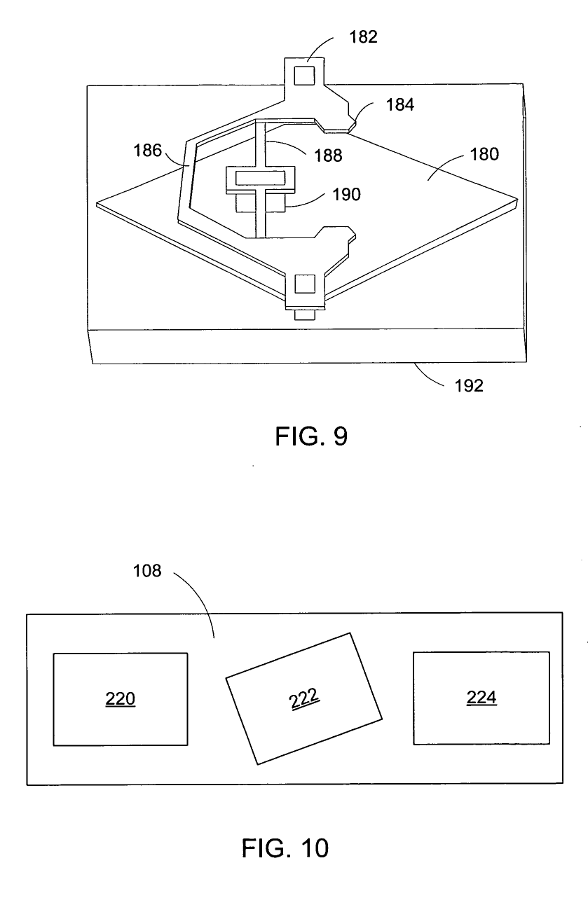

An exemplary micromirror having a cross-section view in FIG. 8 is illustrated in FIG. 9. Referring to FIG. 9, the micromirror comprises reflective deflectable mirror plate 180 that is substantially square in shape. The mirror plate is attached to deformable hinge 188 through hinge contact 190. The deformable hinge is affixed to posts 182 that are formed on light transmissive substrate 192. With this configuration, the mirror plate is capable of rotating relative to substrate 192.

The mirror plate as shown In FIGS. 8 and 9 is attached to the deformable hinge with the attachment point away from the mass center of the mirror plate, such that the mirror plate is capable of rotating asymmetrically along a rotation axis that is parallel to but away from a diagonal of the mirror plate when viewed from the top at a non-deflected state. In another embodiment of the invention, the mirror plate can be attached to the deformable hinge such that the attachment point is substantially at the mass center of the mirror plate, such that the mirror plate is capable of rotating symmetrically along a rotation axis that is substantially coincident with a diagonal of the mirror plate when viewed from the top.

The mirror plate as shown in FIGS. 8 and 9 is formed on a separate plane as the deformable hinge such that the deformable hinge is hidden underneath the mirror plate in the direction of the incident light. This configuration has many benefits, especially in preventing unwanted light scattering from the deformable hinge if being configured otherwise.

The multiple micromirror device arrays can be disposed on the supporting surface of the package substrate (e.g. package substrate 106 in FIG. 1) in many ways so as to satisfy specific requirements. As an example, the micromirror device arrays can be disposed on the package substrate with the device substrate(s) of the arrays is parallel to the package substrate; but with different orientations, as shown in FIG. 10. Referring to FIG. 10, multiple micromirror device arrays 220, 222, and 224 are disposed on supporting surface 108 of the package substrate. The device substrate(s) of the arrays are parallel to the supporting surface. Micromirror device arrays 220 and 224 are arranged with their device array edges being parallel to each other, while micromirror device array is rotated to an angle relative array 220 and array 224 along a rotation axis perpendicular to the supporting surface.

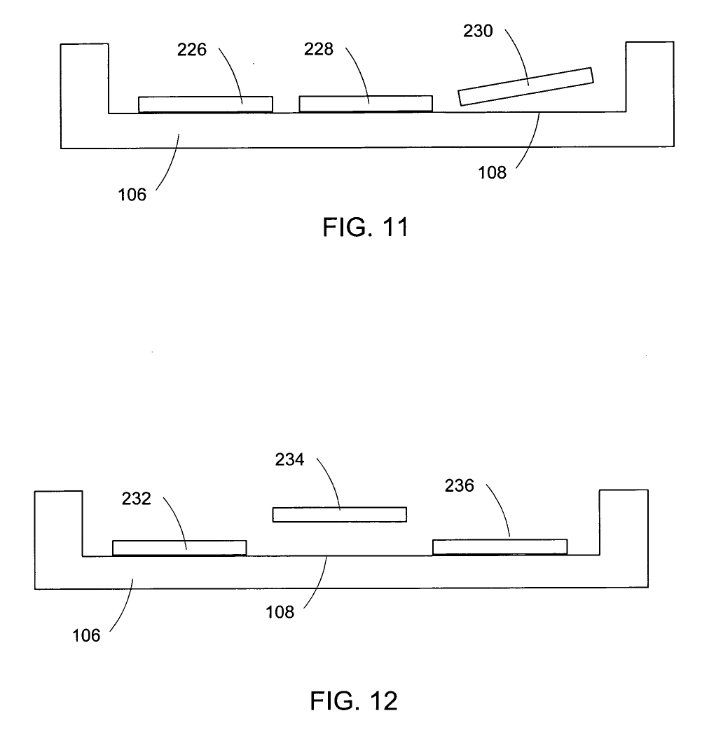

Alternatively, one or more micromirror device arrays in the package can be rotated out of the plane of the supporting surface, as shown in FIG. 11. Referring to FIG. 11, micromirror device arrays 226, 228, and 230 are disposed on supporting surface 108 of package substrate 106. Micromirror device array 230 is rotated along a rotation axis that lies in the supporting surface and along an edge of the micromirror device array.

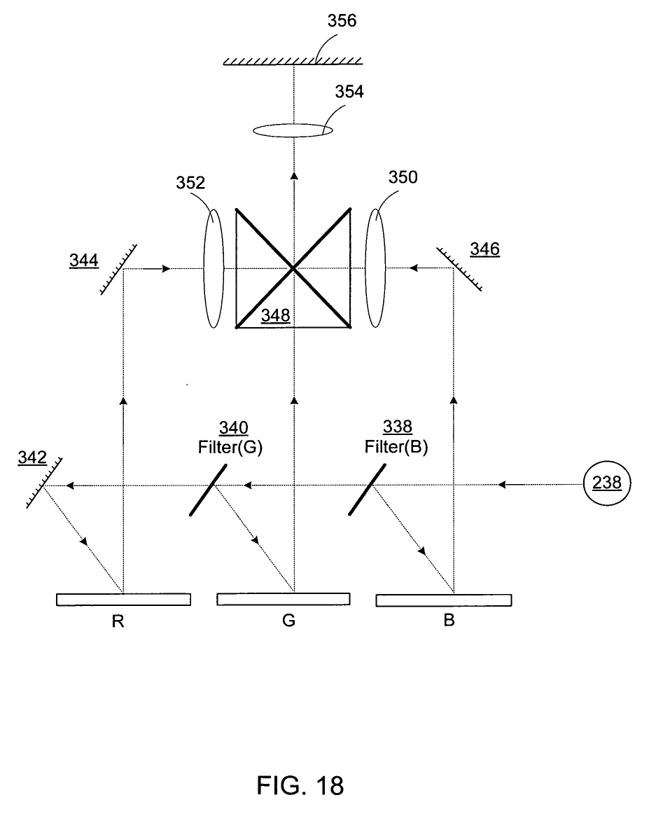

In addition to being rotated, one or more micromirror device arrays in the package can be elevated from the supporting surface, as shown in FIG. 12. Referring to FIG. 12, micromirror device arrays 232, 234, and 236 are disposed on supporting surface 108 of package substrate 106. Micromirror device arrays 232 and 236 are attached to the supporting surface; while micromirror device array 234 is elevated from the supporting surface at a distance. The elevation can be accomplished by inserting an additional plate with suitable thickness between the bottom substrate of micromirror device array 234 and supporting surface 108. This feature may be important in compensating optical path differences in the application of digital display systems, which will be further discussed with reference to FIG. 18.

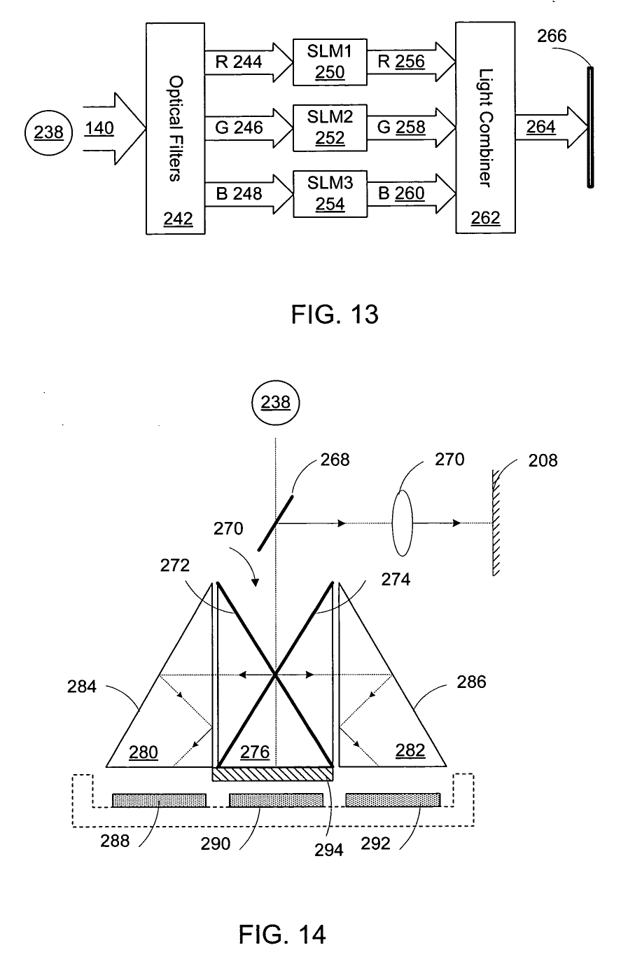

Enclosure of multiple micromirror device arrays as discussed above have many advantages, such as in reducing production cost, increasing production yield, and simplifying system design for digital display systems where multiple pixel arrays are desired to perform light modulation. As an exemplary implementation, FIG. 13 schematically illustrates an exemplary display system utilizing multiple pixel arrays.

Referring to FIG. 13, illumination light 140 from light source 238 is divided into multiple portions with specific wavebands, represented by R 244, G 246, and B 248 after passing the illumination light through optical filter 242. The divided portions are directed to spatial light modulators 250, 252, and 254 correspondingly and are modulated based on image data derived from the desired media contents to be produced. Each spatial light modulator has an array of pixels, such as micromirror devices; and the multiple pixel arrays 256, 258, and 260 are enclosed within a single package as discussed above with reference to FIGS. 1 to 12. The modulated light from the individual spatial light modulators are recombined at light combiner 262. Combined modulated light 264 is then projected on display target 266 for viewing.

The display system shown in FIG. 13 can be implemented in many ways, one of which is illustrated in FIG. 14. Referring to FIG. 14, spatial light modulators 288, 290, and 292 each have an array of pixels, such as micromirror device arrays; and are enclosed within a device package as those discussed with reference to FIG. 1 to FIG. 12. The spatial light modulators are assigned to modulate light beams of different wavebands, such as red, green, and blue (or yellow, cyan, and magenta). Light source 238, such as an arc lamp and LED, generates illumination light. The illumination light is split into a number of light beams with specific wavelengths at standard X-beamsplitter 276. The X-beamsplitter comprises beam splitters 272 and 274 of pre-defined wavelength transmission characteristics. As a way of example, beam splitter 274 reflects red light and passes other colors. Beam splitter 272 reflects blue light and passes other colors. As a consequence, the red light portion of the illumination light is reflected by beam splitter 274 towards folding mirror 284 of optical lens 280. The red light reflected from folding mirror 284 is reflected again at a TIR surface defined by lens 280 and the air gap located between lens 280 and X-beamsplitter 276. The red light from the TIR surface is then directed towards spatial light modulator 288 from where it is modulated.

The blue portion of the illumination light from the light source is reflected at beam splitter 272 towards folding mirror 286 of lens 282. The folding mirror plate directs the blue light to the TIR surface defined by lens 282 and the air gap between lens 282 and X-beamsplitter 276. After the TIR surface, the blue light is incident on spatial light modulator 292 at a desired incident angle.

The green light portion of the illumination light from the light source passes through the beam splitters 272 and 274 at the X-beamsplitter and illuminates spatial light modulator 290.

The spatial light modulators (288, 290, and 292) are enclosed in the same package; and operated to modulate the red, green, and blue portions of the illumination light based on the corresponding image date derived from the desired media contents to be projected. The modulated red, green, and blue light are recombined at the X-beamsplitter. Specifically, the modulated red light at spatial light modulator 280 re-enters into lens 280 and is reflected by folding mirror 284 towards X-beamsplitter 276. At beam splitter 274, the modulated red light is reflected towards folding lens 268, which folds the red light to display target 208 through projection lens 270.

Similarly, the modulated blue light from spatial light modulator 292 re-enters lens 282 and impinges beam splitter 272 through folding lens 286 of lens 282. Beam splitter 272 reflects the modulated blue light towards folding lens 268 from where the modulated blue light is folded to display target 208 through projection lens 270.

The modulated green light from spatial light modulator 290 travels through the X-beamsplitter and folding mirror 268; and is projected to display target 208.

It can be seen that X-beamsplitter 276, lens 280 and 282 in corporation divide the illumination light from the light source into portions of specific wavebands. The divided light portions illuminate corresponding spatial light modulators along separate optical paths. However, the optical paths may not have the same optical length. In the example shown in FIG. 14, the optical paths along the branches towards spatial light modulators 288 and 292 are not the same as that along the path to illuminate spatial light modulator 290. Because of the differences in optical paths, the images of the spatial light modulators (288, 290, and 292) may have different focal points at the display target. This problem can be solved by providing an optical-path-difference (OPD) compensator, such as OPD compensator 294, at one or more optical paths so as to compensate the OPD. The OPD compensator can be composed of optical lens groups to extend the focal length either a small amount or a large amount, which may include re-imaging at an intermediate image plane.

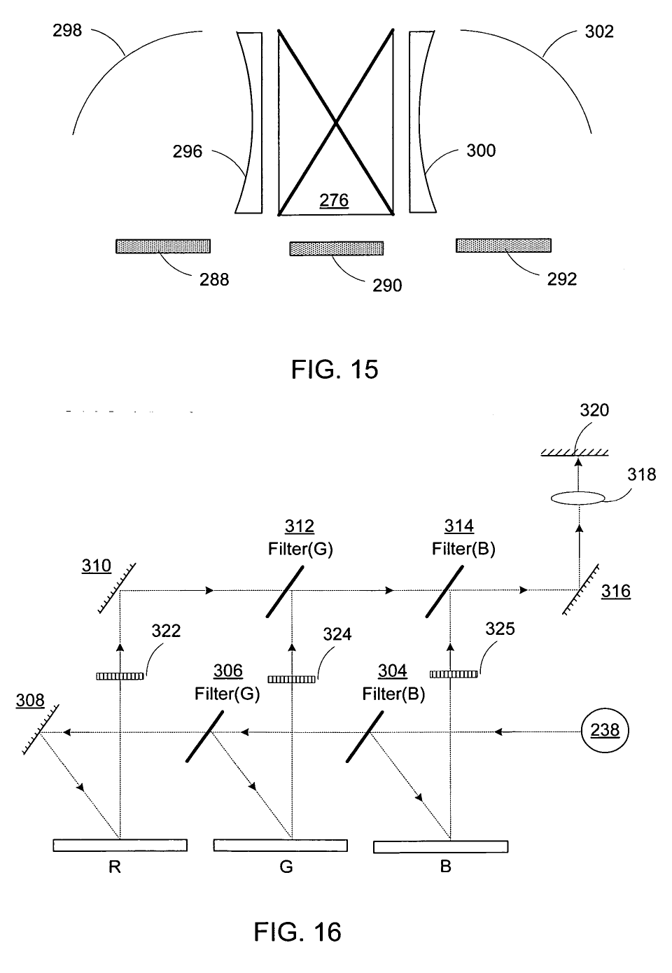

Another exemplary projection system utilizing multiple pixel arrays in a package is demonstratively illustrated in FIG. 15. For simplicity purposes, only the optical filters for splitting the incident light into proper portions, light combiners for combining the modulated light from individual spatial light modulators, and spatial light modulators are shown in the figure. The optical filter comprises standard X-beamsplitter 276 as that discussed with reference to FIG. 14, lenses 296 and 300, and elliptical reflectors 298 and 302.

The X-beamsplitter splits the incident illumination light (e.g. white light) into three portions (e.g. red, green and blue) using the enclosed beam splitters. The split light portions travel along different optical paths. One of the split beam portion travels through lens 296 and reflector 298, and illuminates spatial light modulator 288. The modulated light from spatial light modulator 288 is collected by reflector 298, and reflected to the X-beamsplitter through lens 296. The second split beam portion is incident on spatial light modulator 290 after the optical filter. The modulated second split beam portion at spatial light modulator re-enters the X-beamsplitter. The third split beam portion travels through lens 300 and reflector 302, and illuminates spatial light modulator 292. The modulated light from spatial light modulator 292 is collected by reflector 302, and reflected to the X-beamsplitter through lens 300. The modulated beam portions are recombined at the X-beamsplitter, and projected onto the display target.

In the example shown in FIG. 15, elliptical reflectors 298 and 302 and lenses 296 and 300 are utilized. Such combinations are particularly for compensating the optical-path-differences of different beam portions. Specifically, the pair of reflector 298 and lens 296 in combination forces the focal point of spatial light modulator 288 at the display target be the same as that of spatial light modulator 290. The pair of reflector 298 and lens 296 in combination forces the focal point of spatial light modulator 292 at the display target be the same as that of spatial light modulator 290. In addition to elliptical shape, reflectors 298 and 302 can be other shapes, like spherical, spiral, conic, aspherical and other suitable shapes. Lens 296 can be concave, or an aspheric shape. However, it is preferred that each of the reflectors has a focal point that is elevated from the surfaces of the spatial light modulators, i.e. between the reflector and the spatial light modulator.

Another exemplary projection system employing multiple spatial light modulators enclosed within a package is demonstratively illustrated in FIG. 16. Referring to FIG. 16, Spatial light modulators R, G, B each have an array of pixels, such as micromirror device arrays, and are enclosed within a package as those discussed with reference to FIGS. 1-12. The spatial light modulators are assigned to modulate light beams of different wavebands, such as red, green, and blue (or yellow, cyan, and magenta). For simplicity purposes without losing generality, the following discussion assumes spatial light modulators R, G, and B are assigned to modulate Red, Green, and Blue light beams, respectively. Other arrangements are also applicable.

In operation, white illumination light from light source 238 is directed towards filters 304, 306, and 308. At filter (B) 304, blue light is filtered and reflected to spatial light B; while green and red light beams pass through filter (B) 304. At filter (G) 306, green light is filtered and reflected to spatial light modulator G. The red light beam passes through filter (G) 306; and is reflected to spatial light modulator R by mirror 308 which can alternatively be an optical filter characterized by red light wavebands.

The spatial light modulators respectively modulate the incident red, green, and blue light beams based on corresponding image data derived from desired media contents (videos and images). The modulated light beams are recombined by optical filters 312, 314, mirrors 310 and 316. Specifically, the modulated red light beam by spatial light modulator R is directed to mirror 310, from where it is reflected towards mirror 316. The modulated green light beam from spatial light modulator G is reflected by optical filter (G) 312 and reflected towards mirror 316. The modulated blue light beam from spatial light modulator B is reflected by optical filter (B) 304 and reflected towards mirror 316.

The modulated light beams from all three spatial light modulators arrive at mirror 316; and are folded to projection lens 318 that projects the combined light beams to display target 320.

To compensate differences in optical paths of the light beams, optical-path-difference (OPD) compensators 322, 324, and 325 are provided and placed at the propagation paths of the modulated light beams having otherwise the least optical paths. In the example as shown in the figure, the modulated blue light beam from the spatial light B has the least optical path, and the modulated red light beam from the spatial light modulator R has the longest optical path. To compensate the OPD, OPD compensator 322 can be paced between spatial light modulator R and filter 310 so as to compensate the OPD between the modulated red and blue light beams at mirror 316. OPD compensator 324 can be disposed at other suitable locations at the propagation path of the modulated red light beam, such as between spatial light modulator G and filter 312. As an alternative feature, an OPD compensator 325 can also be placed between spatial light modulator 325 and filter 314 for adjusting the optical path of the reflected light from spatial light modulator B, although is not required to do so.

For the same reason of compensating the OPD, OPD 324 is provided to compensate the OPD between the modulated green light beam and modulated blue light beam at mirror 316.

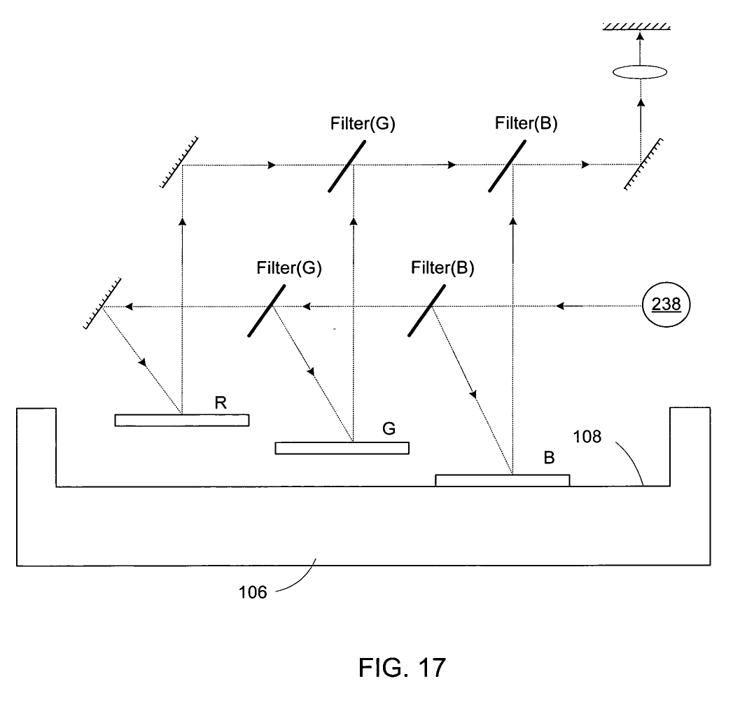

Alternative the OPD compensators, the spatial light modulators enclosed in the package can be geometrically configured to compensate the OPD, one of the examples is demonstratively illustrated in FIG. 17.

Referring to FIG. 17, Spatial light modulators R, G, and B are located in different planes on supporting surface 108 of package substrate 106. Spatial light modulator B, whose corresponding modulated light has the least optical path, is disposed on the supporting surface at a lowest level. Spatial light modulator G, whose modulated light beam has the intermediate length of optical path, is elevated from the supporting surface and disposed at a plane higher than the plane of spatial light modulator B. Because the modulated light from spatial light modulator R has the longest optical path, spatial light modulator R is elevated from the supporting surface and disposed at a plane that is higher than both planes on which spatial light modulators B and G are disposed.

The spatial light modulators R and G can be elevated above the supporting surface of the package substrate in many ways. For example, the spatial light modulators can be elevated with insert plates and suitable materials. The elevated vertical distances are determined by the OPD between the spatial light modulators and the reference optical path, such as the shortest optical path.

Another exemplary projection system employing multiple spatial light modulators in a package according to the embodiment of the invention is demonstratively illustrated in FIG. 18. Referring to FIG. 18, spatial light modulators R, G, and B are enclosed in a package as those discussed with reference to FIG. 1 to FIG. 12. A beam of illumination light, such as white light, is emitted from light source 238, and divided into portions of specific wavebands, such as red, green, and blue (or yellow, cyan, and magenta) after optical filters 338, 340, and 342. In the example where spatial light modulators 338, 340, and 342 are assigned to modulate blue, green, and red light beams, respectively, optical filters 338, 240, and 342 respectively reflects light beams of blue waveband, green waveband, and red waveband, to the corresponding spatial light modulators B, G, and R.

The modulated light beams from spatial light modulators R and B enter X-beamsplitter 348 through folding mirrors 344 and 346, and lens groups 352 and 350, respectively. At the X-beamsplitter, the modulated light beams from spatial light modulators R, G, and B are combined together; and directed to projection lens 354 that projects the combined and modulated light beams to display target 356. In the example shown in the figure, the OPD between the optical path towards spatial light modulator G and modulator R; and the OPD between the optical path towards spatial light modulator G and modulator B, are compensated by lens groups 352 and 350. Alternatively, the OPD can be compensated using optical filters and other suitable optical elements.

When multiple spatial light modulators are utilized in projecting media content in a display target, the gaps between adjacent spatial light modulators in the package may also be imaged on the display target. In another word, the images from produced by the modulated light from different spatial light modulators may have gaps therebetween. This problem can be avoided using multiple folding mirrors that are angled relative to each other so as to meld the images from different spatial light modulators on the display target.

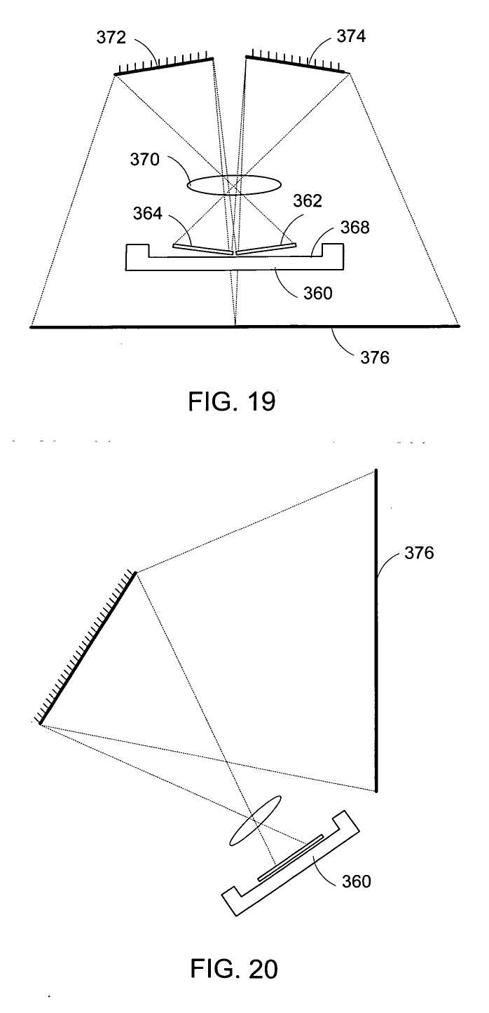

As a way of example in a rear-projection system wherein two spatial light modulators are enclosed in package and used simultaneously for producing the desired media content, multiple folding mirrors can be provided, as shown in FIG. 19. Referring to FIG. 19, spatial light modulators 364 and 362 are disposed on supporting surface 368 of package substrate 360. Each spatial light modulator has an angle to the supporting surface of the package substrate. Folding mirrors 372 and 374 are provided for reflecting the modulated light from spatial light modulators 364 and 360 to display target 376. For melding the images generated by the modulated light from the spatial light modulators, the folding mirrors have an angle relative to each other so as to cancel the image of the gap between the spatial light modulators. In association with the angled folding mirrors, the angles between the device substrates of the spatial light modulators and the supporting surface are determined based on the relative angles and distance between folding mirrors 372 and 374. The side vide of the projection system in FIG. 19 is illustrated in FIG. 20. In an alternate embodiment, wedge shaped prisms can be placed in front of one or more spatial light modulators to provide optical tilt.

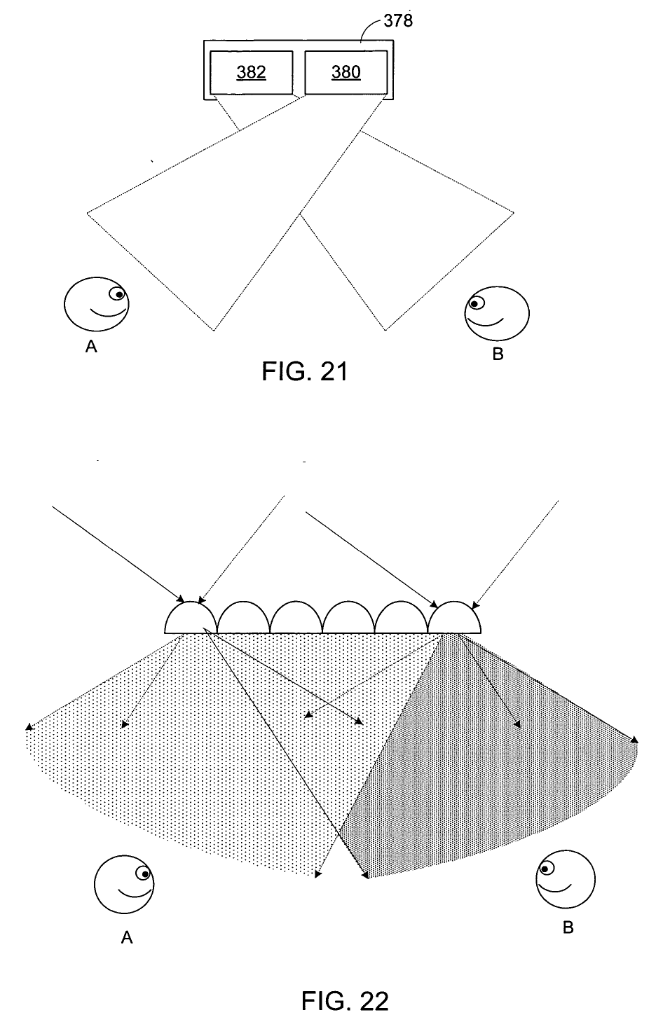

The multiple spatial light modulators enclosed in the package can be operated to project different portions of the same media content (e.g. different color portions of the same image). In operation, the multiple spatial light modulators are operated based on the image data derived from the same media content. Alternatively, different media contents can be simultaneously produced by the multiple spatial light modulators so as to provide different viewing experiences for viewers of different interests, as shown in FIG. 21. Referring to FIG. 21, spatial light modulators 382 and 380 are disposed on supporting surface 378 of the package substrate. In operation, spatial light modulators 382 and 380 are simultaneously operated based on image data derived from different media contents for viewers A and B. For example, spatial light modulator A can be operated to produce videos from one TV channel; while spatial light modulator is operated to project videos from a different TV channel.

In order to provide non-interference viewing effect for both viewers A and B, the projected light from spatial light modulators 382 and 380 are along different viewing directions. Accordingly, the screen of the projection system is preferably modified such that the images from different spatial light modulators can only be viewed along certain viewing angles. FIG. 22 demonstratively illustrates an exemplary screen usable for the display system in FIG. 21. Referring to FIG. 22, the screen comprises a series of hemispherical optical beads arranged on one side of the light transmissive screen. The modulated light from one spatial light modulator is projected on one half (e.g. the right half) of the optical beads; while the modulated light from the other spatial light modulator is projected on the other half (e.g. the left half) of the optical beads. The image projected on the right half of the optical bead is viewable to viewer A; while the image projected on the left half of the optical beads is viewable to viewer B, as shown in the figure. Of course, other optical designs are applicable. The capability of providing different viewing effects can be incorporated with other features, such as different sound effects. Specifically, viewers A and B may be provided with different sound tracks, regardless whether they are watching the same media content or not.

It will be appreciated by those skilled in the art that a new and useful package enclosing multiple pixel arrays has been described herein. In view of the many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention.

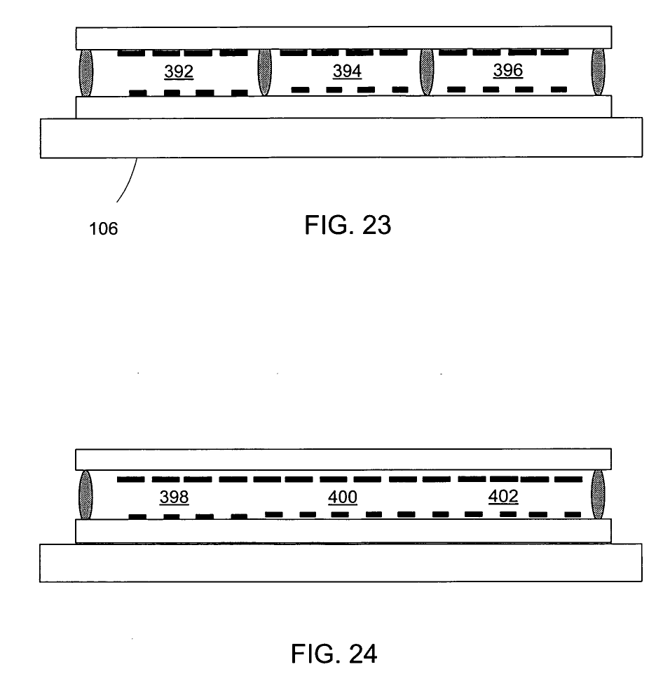

As one example, the multiple micromirror arrays in the package device can be formed on the wafer level without singulation, as shown in FIG. 23. Referring to FIG. 23, micromirror arrays 392, 394, and 396 are formed on the wafer level. Specifically, a plurality of micromirror dies each having an array of mirror plates are formed on the first wafer, such as the light transmissive substrate. The first wafer is then assembled to the second wafer formed thereon a plurality of electrode dies each having an array of addressing electrodes. The wafer assembly is then singulated into die-assembly groups with each group having a desired number of die assemblies (e.g. the desired number of micromirror arrays). The die-assembly group is then disposed on package substrate 106.

In the example shown in FIG. 23, each micromirror array comprises one or more spacers disposed between the two device substrates for maintaining a uniform distance between the two device substrates. Alternatively, the micromirrors can be continuously formed on the wafers, as shown in FIG. 24.

Referring to FIG. 24, micromirror arrays 398, 400, and 402 are continuously formed on the upper wafer which is transmissive to visible light. The upper wafer is bonded to the lower wafer that has a plurality of electrode dies with each die comprising an array of addressing electrodes. The wafer assembly is disposed on the package substrate.

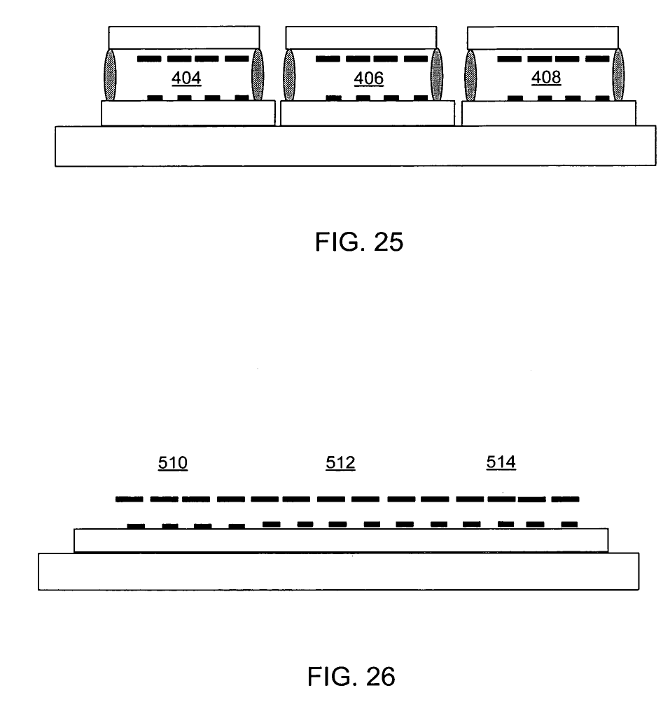

Alternative to the examples discussed above with reference to FIG. 23 and FIG. 24, the wafer assembly having the micromirror arrays and addressing electrode arrays can be singulated into individual micromirror array devices 404, 406, and 408, as shown in FIG. 25. The singulated individual micromirror array devices are disposed on the same package substrate.

Other than forming the micromirrors and addressing electrodes on different substrates, they can be formed on the same substrate, such as a semiconductor substrate, as shown in FIG. 26.

Referring to FIG. 26, micromirror arrays 510, 512, and 514 are formed on the semiconductor substrate. Specifically, the mirror plates and addressing electrodes in each micromirror array are formed on the same semiconductor substrate. All micromirror arrays are disposed on the package substrate with the semiconductor substrate being attached to the surface of the package substrate.

1. A system used for producing an image, comprising:
a package comprising first and second arrays of pixels enclosed within a space between a package substrate and a package cover; and
wherein each array has a aspect ratio of 16:9

2. The system of claim 1, wherein the pixels are substantially continuous in the absence of a structure that is not substantially the same as the other pixels.

3. The system of claim 2, wherein the pixels are micromirror devices.

4. (canceled)

5. The system of claim 3, wherein the micromirror devices are formed on one substrate.

6. (canceled)

7. (canceled)

8. The system of claim 2, further comprising:
a light blocking/absorbing mask comprising first and second blank areas superimposed on the first and second pixel arrays, such that the first and second pixel arrays are exposed from the blank areas.

9. The system of claim 8, wherein the mask is disposed on a substrate on which the pixel arrays are formed.

10. The system of claim 8, wherein the mask is disposed on the package cover.

11. (canceled)

12. The system of claim 1, wherein the first and second pixel arrays are separated by a gap.

13. (canceled)

14. (canceled)

15. The system of claim 12, wherein the gap is covered by a light transmissive material.

16. The system of claim 12, further comprising a light blocking/absorbing mask aligned to the first and second pixel arrays such that light reflected from the gas is absorbed or blocked by the mask.

17. The system of claim 16, wherein the mask is disposed on the pixels.

18. (canceled)

19. The system of claim 1, wherein the pixel arrays are formed on singulated substrates.

20-23. (canceled)

24. The system of claim 19, wherein the first pixel array is placed such that a substrate on which the pixels are formed is parallel to the supporting surface of the package substrate; and wherein the second pixel array is elevated from the supporting surface such that a substrate on which the pixels of the second pixel array are formed has a different vertical distance from the supporting surface that that between the substrate of the first pixel array and the supporting surface.

25-64. (canceled)

65. A device, comprising:
a set of pixel arrays disposed on one single package substrate; and
a light blocking mask having a plurality of aperture areas each of which is aligned to one of the set of pixel arrays.

66. The device of claim 65, wherein the pixel array comprises an array of micromirror devices, each of which comprises:
a substrate;
a reflective and deflectable mirror plate;
a deformable hinge attached to the mirror plate; and
a post formed on the substrate and connected to the deformable hinge such that the mirror plate is capable of moving relative to the substrate.

67. The device of claim 65, wherein the package substrate is ceramic.

68. The device of claim 66, wherein the substrate is a semiconductor substrate having an addressing electrode for moving the mirror plate.

69. The system of claim 66, wherein the substrate is a light transmissive substrate bonded to a semiconductor substrate having an addressing electrode for moving the mirror plate.

70. The system of claim 66, wherein the pixel array has an aspect ratio of 16:9.

71. The system of claim 66, wherein the pixel array has a natural resolution of 512×384 or higher.

72. The system of claim 66, wherein the pixel array has a natural resolution of 960×540 or higher.

73. The system of claim 66, wherein the pixel array has a natural resolution of 1024×768 or higher.

74. The system of claim 35, wherein the pixel array has a natural resolution of 1920×1080 or higher.

75-84. (canceled)

85. A method, comprising:
illuminating a device that comprises a plurality of reflective and deflectable mirror plates with a illumination light beam;
switching the pixels of first and second arrays of pixels on the device between an ON and OFF state so as to reflecting the illumination light beam into different directions based on a set of image data derived from a desired image;
operating the pixels in a barrier between the first and second pixel arrays independent from the image data; and
projecting the reflected light from one of the different directions on a screen.

86. The method of claim 85, wherein the pixels at the barrier is set to the OFF state.

87. The method of claim 85, wherein the pixels at the barrier is set to the ON state.

88. The method of claim 85, wherein the pixels are micromirror devices.

89. The method of claim 85, wherein the barrier has a width that is larger than a center-to-center distance of the micromirror array.

90. The method of claim 89, wherein the barrier has a width that is larger than 5 times the center-to-center distance of the micromirror array.

91. The method of claim 90, wherein the barrier has a width that is 14 microns or larger.

92. The method of claim 90, wherein the barrier has a width that is 70 microns or larger.

93. The method of claim 90, wherein the barrier has a width that is 140 microns or larger.
